(19) United States
(12) Patent Application Publication
(10) Pub. No.: US 2025/0029039 A1
(43) Pub. Date: Jan. 23, 2025

(54) MACHINE-ASSISTED PROCESS MODELING AND VALIDATION

(71) Applicant: SAP SE, Walldorf (DE)

(72) Inventors: ABHINAV KUMAR, Bengaluru (IN); Vikas ROHATGI, Bengaluru (IN)

(21) Appl. No.: 18/223,685

(22) Filed: Jul. 19, 2023

(51) Int. Cl. G06Q 10/0633; G06Q 10/067

(52) U.S. Cl. CPC G06Q 10/0633; G06Q 10/067

(57) ABSTRACT

Disclosed herein are system, method, and computer program product embodiments for machine-assisted process modeling and validation. An embodiment operates by receiving, by at least one processor, a process document describing a process in a user locale. The embodiment then generates the model notation in accordance with a model notation format by processing the process document with a deep learning technique based on a prompt for modeling the process document. The embodiment then outputs the model notation.

### BACKGROUND

Business processes are the backbone of any enterprise for representing either their core or extension processes. A process modeling system (also known as “workflow management software”) can be used to model a structured process, case, and/or decision for execution. The process modeling system may use various model notations to model business processes, business cases, and/or decisions. A user or an auditor often needs to validate that the model notation created using the process modeling system describes the model as intended. However, validation of model notations can sometimes be difficult. First, it is often computationally expensive to validate model notations. Second, it is often impossible to validate the entire model notations. Lastly, validation of model notations often fails because the associated tests may produce false negatives.

### BRIEF DESCRIPTION OF THE DRAWINGS

The accompanying drawings are incorporated herein and form a part of the specification.

FIG. 1 is a block diagram of a process modeling system, according to some embodiments.

FIG. 2 is an exemplary output showing a difference between an envisioned process and an actual process modeled in the process modeling system, according to some embodiments.

FIG. 3 is a flowchart for a method for an automated process modeling, according to an embodiment.

FIG. 4 is a flowchart for a method for a difference generation, according to an embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for automated modeling and/or validating business processes, cases, and/or decisions.

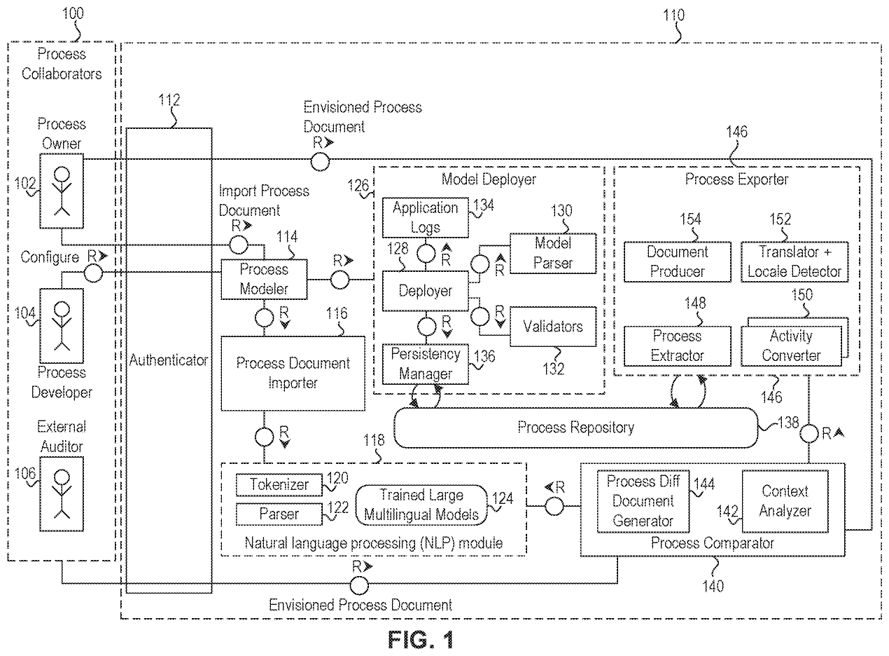

FIG. 1 is a block diagram of a process modeling system, according to some embodiments. In FIG. 1, objects surrounded by solid lines represent software modules or entities. In FIG. 1, some interrelated software modules or entities are surrounded by dashed lines. Solid lines connecting software objects or entities in FIG. 1 represent a processing flow. The “R” associated with the flow of processing represents a request and indicates that the request is made according to the direction of the arrow. The software module that receives the request may return a response to the sender of the request.

Process collaborators 100 are entities using a process modeling system 110. Process collaborators 100 may include a process owner 102, a process developer 104, and/or an external auditor 106. A process owner 102 may be a business person who owns and defines a process. A process developer 104 may be a developer who models envisioned process using the process modeling system 110. An external auditor 106 may be an auditor who certifies that an implemented process implemented using the process modeling system 110 is same as an envisioned or documented by the process owner 102. In FIG. 1, each entity is described with its role for the sake of clarity. The roles and number of entities are not limited to those shown in FIG. 1. A single entity may use the process modeling system 110, or additional entities may use the process modeling system 110.

The process modeling system 110 is a system for modeling and/or modeling the business process owned and developed by the process owner 102. The process modeling system 110 may include software modules. Each of the software modules works together to make the process modeling system 110 operate. Each software module is represented in FIG. 1 as a module with an appropriate granularity for illustrative purposes. The granularity of modularization is not limited to that shown in FIG. 1.

An authenticator 112 is a software module to authenticate the process collaborators 100. The authentication may be performed for each entity of the process collaborators 100. The authentication may be performed each time each entity of the process collaborators 100 accesses each software module of the process modeling system 110, or it may be performed every predetermined period of time.

A process modeler 114 is a user interface editor for editing or creating model notations. The process modeler 114 may receive a human readable process document in different locale by importing the process document. The process owner 102 or the process developer 104 may define and import the process document into the process modeler 114.

The process modeler 114 may output the generated model notation to the process developer 104 or other process collaborators 100. Thus, the process developer 104 can configure the process via the process modeler 114. For example, the process developer 104 may configure a destination of a service task. The process developer 104 may configure the destination by setting details of the destination system (URL, Username, Password, etc.). The process developer 104 may also write functional test cases using the process modeler 114. For instance, as described below, when modeling for leave application process using the process modeling system 110, the process developer 104 can make the necessary configurations to fetch leave quotas from the human capital management (HCM) system. As such, the developer 104 can perform various configurations, tests, etc. via the process modeler 114.

The process document may be a document that describes a business process in user locale. The user locale is a natural language used by the user (e.g., German, French etc.). By way of example, a process document may contain the following description(s): 1) An employee fills out a leave application form where the fields “Employee Id”, “Employee Name”, “Type Of Leave”, “Start Date”, “Start Time”, “End Date”, “End Time”, “Reason of Leave” are mandatory. 2) An automated validation runs on the submitted form to check if the employee is not requesting leave above his/her permitted quota, else the leave application is rejected automatically. The leave quota may be is stored on or may be fetched from a human resource management system. 3) Employee's manager receives the leave application and has two days of time to “Approve”/“Reject” the leave application. 4) If the Employee's manager fails to take any action in 2 days, the manager's manager receives the leave application and has two days of time to “Approve”/“Reject” the leave request. 5) If the manager's manager fails to take any action in two days, the leave application is automatically approved.

The process modeler 114 may receive a prompt for modeling the process document. The process modeler 114 may receive the prompt from the process owner 102 or other process collaborators 100. The process modeler 114 may receive the prompt from another software module of the process modeling system. The prompt may be a text that instructs how to model the process document. The prompt may be a text of “Use appropriate modeling notation and provide a model to depict following <process document>.” The receipt of a prompt may also be triggered via an application programming interface (API) or other means. In another example, the receipt of a prompt may be an automated step as part of importing a process document. The receipt of a prompt may be accomplished using various other mechanism as would be appreciated by a person of ordinary skill in the art.

The process modeler 114 may transmit a request with the process document and the prompt to a process document importer 116 to generate the model notation.

The process document importer 116 may be an importer of the process document. The process document importer 116 may collaborate with a natural language processing (NLP) module 118 to convert the process document imported from the process modeler 114 into the various model notations including, but not limited to, business process modeling notation (BPMN), case management model and notation (CMMN), and decision model and notation (DMN). The process document importer 116 may transmit a request with the imported process document and the prompt to the NLP module 118 to generate the model notation.

The NLP module 118 may tokenize and parse the process document and generate the model notations. The NLP module 118 may include tokenizer 120, parser 122, and trained large multilingual models 124.

The tokenizer 120 may tokenize the process document. Tokenization is the process of dividing sentences into predetermined units.

The parser 122 may parse the tokenized process document. The parser 122 may analyze a syntax of the tokenized process document and generates structured data to be processed by the trained large multilingual models 124.

The trained large multilingual models 124 may generate the model notation. The trained large multilingual models 124 may have a large number of parameters which were trained on a large amount of data to get correct weights for the parameters to minimize an error of generated output. The trained large multilingual models 124 may be models modeled based on deep learning techniques including, but not limited to, a large language model (LLM). The LLM may be generative transformers or other language models. The LLM may be modeled based on deep learning techniques. The trained large multilingual models 124 may be other deep learning models such as a memory augmented neural networks (MANN) or other language models modeled based on deep learning techniques.

The NLP module 118 may generate the model notation in accordance with a model notation format including, but not limited to, BPMN, CMMN, DMN, or any other model notations by processing the process document. The BPMN is a notation for modeling a business process. The CMMN is a notation for modeling a business case. The DMN is a notation for modeling a business decision. The model notation format may be described in various data formats including, but not limited to, an extensible markup language (XML) and JavaScript™ object notation (JSON).

The NLP module 118 may determine an appropriate model notation format to model the process document based on a context of the process document, and generate the model notation in accordance with the determined model notation. For example, the NLP module 118 may determine the model notation format of the CMMN as an appropriate model notation format other than the BPMN when the NLP module 118 detects that the documented process is not well-structured. The NLP module 118 may use the model notation format if a specific model notation format is designated in the prompt. The NLP module 118 may determine multiple model notation formats to model the process document as a hybrid model. The NLP module 118 may notify, via the process modeler 114, the process owner 102 or other process collaborators 100 of the determined model notation format.

The NLP module 118 may detect that the process document includes a usage of personal information or personal sensitive information (collectively referred to as personal information in this disclosure). The personal information may include information that can identify an individual, the use of which may be subject to certain restrictions imposed by laws and regulations. The NLP module 118 may output, via the process modeler 114, a notification that indicates that the process document includes the usage of personal information to the process owner 102 or other process collaborators 100.

The NLP module 118 may, instead of generating the model notation directly as described, generate an intermediate document describing the process similar to the model notations to generate the model notations. The NLP module 118 may provide the intermediate document to the process collaborators 100. For example, for the process document 1) through 5) specified in the above paragraph, the NLP module 118 may generate the following intermediate documents: 1) The document describes a process for leave application and approval. 2) The process starts with a “Start” event, which represents the submission of a leave application. The leave application is created by an employee after filling “Leave Application Form” which has “Employee Id”, “Employee Name”, “Type Of Leave”, “Start Date”, “Start Time”, “End Date”, “End Time”, “Reason of Leave” as mandatory fields. 3) Next task is “Validate Leave Quota”, which checks if the employee has sufficient leave quota for the requested leave. The quota can be found using “Service Task” named “Get Leave Quota from the human resource management system”, which retrieves the leave quota from the human resource management system. 4) The validation is followed by an “Exclusive Gateway” that determines if the leave is within quota or not. If it is not within quota, the process terminates. If it is within quota, the process proceeds to a “Manager Approval” Human task, where the employee's manager is expected to approve or reject the leave request. 5) After the manager approval, there is another exclusive gateway, “Manager Decision Gateway,” which determines the next step based on the manager's decision. If the leave is approved, the process proceeds to the end. If the leave is rejected, the process ends. If the manager fails to take any action within two days, the process proceeds to a “Manager's Manager Approval” Human task, where the manager's manager has two days to approve or reject the leave request. 6) The process ends after the “Manager's Manager Approval” task, the leave is approved if the manager's manager fails to take any action within two days. The NLP module 118 may generate the model notation based on the intermediate document. The intermediate document can be a standardized English document. The NLP module 118 may use a deep learning technique, such as the LLM model which is trained only in English in a particular English dialect whose usage is closer to the model notation. As such, the process modeling system 110 can not only convert the process document directly into the model notations, but also convert the process document into the intermediate document and the intermediate document into the model notations. The intermediate document can be used by the process collaborators 100 for reference.

The NLP module 118 may return the generated model notation to the process document importer 116. The process document importer 116 may return the generated model notation to the process modeler 114. The process developer 104 can configure the process via the process modeler 114 in response to the generated model notation, as already explained. The process modeler 114 may transmit a request to a model deployer 126 to deploy the generated model notation.

The model deployer 126 may deploy the model notation. Deployment is the process of making the model notation available and running on specific systems, such as a BPMN system, a CMMN system, or a DMN system, etc. The deployment enables the execution of processes in accordance with the model notation on the system. The model deployer 126 may include a deployer 128, a model parser 130, validators 132, application logs 134, and a persistency manager 136.

The deployer 128 may deploy the model notation by collaborating with the model parsers 130, the validators 132, the application logs 134, and the persistency manager 136. The deployer 128 may contain individual deployers including BPMN deployer, CMMN deployer, and DMN deployer.

The model parser 130 may parse the model notation during the deployment responsive to a request from the deployer 128. The validators 132 may validate the model notation during the deployment responsive to a request from the deployer 128 by performing a syntactic check.

The validators 132 may detect that the process document lacks information necessary (or preferable) to have in order to perform the modeling while deploying the model notation by performing the syntactic check. For example, the validators 132 may detect the lack of information when the NLP module determines that the process document specifies actions to be taken after an invoice submission is approved, but does not specify actions to be taken after an invoice submission is rejected. The validators 132 may output, via the process modeler 114, a notification indicating that the process document lacks the information to the process owner 102 or other process collaborators 100. The validators 132 can be validators for various model notations. For example, the validators 132 can be a BPMN validator, CMMN validator, DMN validator, any other model notation validator, or a combination thereof.

The NLP module 118 may also detect that the generated model notation contains an error. The error may include a syntax error. The NLP module 118 may output, via the process modeler 114, a notification that indicates that the generated model notation contains the error to the process owner 102 or other process collaborators 100. As such, if there are glaring issue in the process document, the process owner 102 or other process collaborators 100 may recognize the issue.

The application logs 134 may manage the process deployment logs responsive to a request from the deployer 128. The persistency manager may manage a multi-tenant persistency, which can be used to store the model notation responsive to a request from the deployer 128 by collaborating with a process repository 138. The process repository 138 may be a repository to store the deployed model notation. In this disclosure, the deployed model notation may also be referred to as a deployed process.

Once the deployment is done, the process owner 102 or the external auditor 106 may want to check if the deployed process is same as an envisioned process. However, manually checking deployed processes empirically (through testing) is costly and can result in false positives. Then, to perform more reliable validation, the process owner 102 or the external auditor 106 may import an envisioned process document in user locale to a process comparator 140. The envisioned process document may be a document describing a process in the natural language. The envisioned process document may describe the process envisioned by the process owner 102.

The process comparator 140 may import the envisioned process document. The process comparator 140 may include a context analyzer 142 and a process diff document generator 144. The process comparator 140 may output a difference between the envisioned process document and a generated document for deployed process. The generated document for deployed process may be a document generated by converting the deployed model notation in the natural language. The process comparator 140 may transmit a request with the envisioned process document to the process exporter 146 to generate the generated document for deployed process.

The process exporter 146 may export the generated document for deployed process responsive to the request from the process comparator 140. The process exporter 146 may include a process extractor 148, an activity converter 150, a translator with a locale detector 152, and a document producer 154. The process exporter 146 may perform operations by referring to the deployed model notation stored in the process repository 138 via the process extractor 148 as needed. The process extractor 148 may extract the deployed model notation from the process repository 138.

The activity converter 150 may convert the deployed model notation in the natural language. The activity converter 150 may include various activity converters corresponding to activity types of an object expressed in the model notation. The activity types may include start event, service task, script task, human task, transaction, call activity, exclusive gateway, event based gateway, parallel gateway, timer event, and escalation event etc. There may be one activity converter 150 per the activity type. A start event converter or a form trigger, as a type of the activity converter 150, may produce a document segment containing “Form with title “Leave Application Form” with mandatory fields “Employee Id”, “Type of Leave”, “Start Date”, “Start Time”, “End Date”, “End Time”, “Reason of Leave” triggers the process.” A service task converter, as the activity converter 150, may produce a document segment containing “Service Task calls <url> and fetches leave quota property.” A human task converter, a type of as the activity converter 150, may produce a document segment containing “Human task reaches the Manager's Inbox for approval/rejection.” An exclusive gateway converter, a type of as the activity converter 150, may produce a document segment containing “There are two possible outcomes of Manager's approval task—one is leave approved and other is leave rejected.” A boundary timer event converter, a type of as the activity converter 150, may produce a document segment containing “Manager's approval task is due within 2 days. Failing which Manager's manager approval task will get triggered.”

The activity converter 150 may convert the deployed model notation in the natural language by generating a predetermined string corresponding to an object included in the deployed model notation. The activity converter 150 may use a parameterized template matching method to generate the predetermined string. The parameterized template has a template corresponding to the objects included in the model notation as parameters. Conversion using parameterized templates differs from conversion using large-scale language models, which generate plausible documents using past training data, in that it generates a predetermined string that corresponds with the objects in the model notation. For example, the activity converter 150 may refer to the list of natural languages corresponding to the objects defined in the notation model format as the template. The activity converter 150 may use a toString method to generate the predetermined string by using the template. As such, the activity converter 150 may convert the deployed model notation in the natural language by using a predetermined parameterized template.

The translator with the locale detector 152 may identify the locale of the envisioned process document. The translator with the locale detector 152 may convert the generated document in the same locale as the envisioned process document.

The document producer 154 generates the generated document for deployed process. The document producer 154 may generate the generated document containing details of the deployed process converted by the activity converter 150 and translated by the locale detector 152. The process exporter 146 may send the generated document for deployed process generated by the document producer 154 to the process comparator 140.

The context analyzer 142 may fragment the envisioned process document and the generated document for deployed process based on related activities context. The context analyzer 142 may collaborate with the NLP module 118 to fragment the envisioned process document and the generated document for deployed process.

The process diff document generator 144 may generate the difference between the envisioned process document and the generated document for deployed process. The process diff document generator 144 generates the difference based on the fragmented envisioned process document and the fragmented generated document for deployed process. The process diff document generator 144 may extract contexts from the envisioned process document and the generated document for deployed process. The process diff document generator 144 may compare the extracted context to generate the difference. The process diff document generator 144 may collaborate with the NLP module 118 to generate the logical diff details. The process diff document generator 144 may be a transformer based language model. The transformer based language model may be a bidirectional encoder representations from transformers (BERT). BERT is bidirectional model which takes into account the context of whole sentence. BERT uses contextual embedding, which encodes each word in sentence based on surrounding words. To compare two sentences, BERT takes embedding of each sentence and calculates similarity score using cosine similarity. Based on the calculated score, the process diff document generator 144 can determine how similar sentences are. The output of BERT is numeric. The output may take a value between 0 and 1, where 1 indicates same sentences. The process diff document generator 144 may set thresholds to convert the score from numeric to binary. For example, if the process diff document generator 144 determines that the score is above 0.80, the process diff document generator 144 may determine that the compared sentences are similar. For example, if the process diff document generator 144 determines that the score is lower than 0.80, the process diff document generator 144 may determine that the compared sentences are different. The process diff document generator 144 may also use semantic matching with sentence-BERT to generate the difference.

The process diff document generator 144 may output the difference between the envisioned process document and the generated document for deployed process via the process comparator 140.

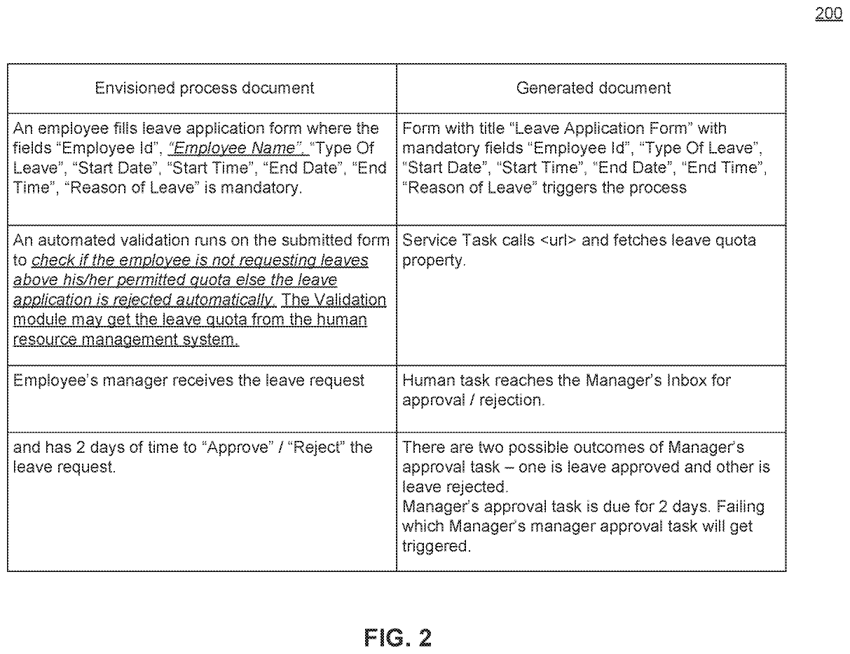

FIG. 2 is an exemplary difference output 200 showing a difference between an envisioned process and an actual process modeled in the process modeling system, according to some embodiments. The process diff document generator 144 may output the envisioned process document and the generated document for deployed process side by side as shown in FIG. 2.

The process diff document generator 144 may emphasize (highlighting, underlining, changing fonts, italic, bold etc.) the differences between the envisioned process document and the generated document. For example, as shown in FIG. 2, if the process diff document generator 144 determines that there is a difference in that the envisioned process document requires the employee to submit the employee's name, but the generated document for deployed process does not require the employee to submit the employee's name, the process diff document generator 144 may underline and italic the “Employee Name” of the envisioned process document to emphasize the difference. Similarly, as shown in FIG. 2, if the process diff document generator 144 determines that there is a difference in that the envisioned process document requires the system to check whether the requested leave beyond the employee's authorized quota and automatically deny the leave request if the quota is exceeded the process, but the generated document for deployed process does not require such operation, the process diff document generator 144 may underline and italic the “check if the employee is not requesting leaves above his/her permitted quota else the leave application is rejected automatically” of the envisioned process document to emphasize the difference.

The process diff document generator 144 may vary the emphasis according to the degree of difference. For example, in the two examples above, the required behavior specified in one document is not present in the other document, so the difference is underlined and changed to italic because the degree of difference can be said to be strong. However, if the difference is only informative, the difference may be emphasized in a different way. The process diff document generator 144 may just underline the informative difference. For example, if the process diff document generator 144 determines that there is a difference in that the envisioned process document requires that the validation module may get the leave quota from the human resource management system, but the generated document for deployed process does not mention such operation, the process diff document generator 144 may underline the “The Validation module may get the leave quota from the human resource management system.” of the envisioned process document to emphasize the difference. In addition to underlining and italicizing, various other methods can be used to add differences in emphasis, such as changing the color of the emphasis or the font.

Thus, even someone unfamiliar with deciphering model notation, such as the process owner 102 or the external auditor 106, can intuitively understand that the deployed process is different from the envisioned process and where and how it differs.

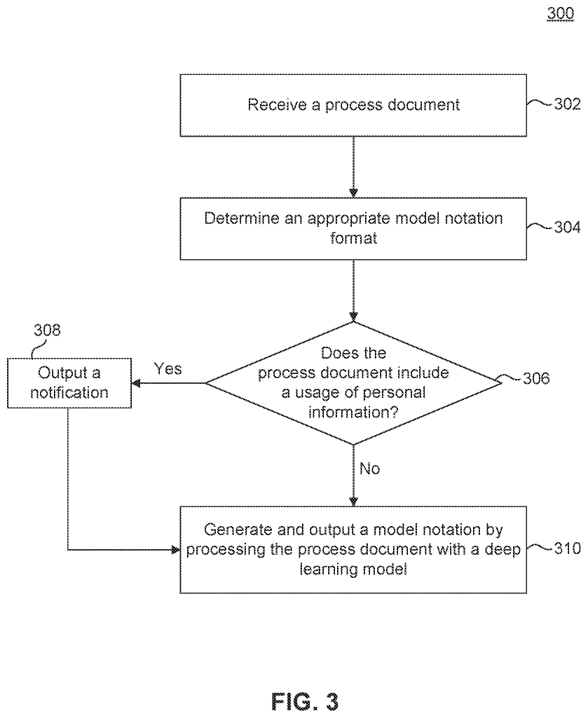

FIG. 3 is a flowchart for a method 300 for an automated process, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIGS. 1 and 2. However, method 300 is not limited to that example embodiment.

In 302, the process modeling system 110 receives a process document in user locale. For example, the process modeler 114 may receive the process document.

In 304, the process modeling system 110 determines an appropriate model notation format to model the process document. For example, the NLP module 118 may determine an appropriate model notation format to model the process document based on a context of the process document, and generate the model notation in accordance with the determined model notation.

In 306, the process modeling system 110 detects whether the process document includes a usage of personal information. For example, the NLP module 118 may detect that the process document includes a usage of personal information or personal sensitive information (collectively referred to as personal information in this disclosure).

In 308, if the process modeling system 110 detects that the process document includes a usage of personal information, the process modeling system 110 outputs a notification. For example, the NLP module 118 may output, via the process modeler 114, a notification that indicates that the process document includes the usage of personal information to the process owner 102 or other process collaborators 100.

In 310, the process modeling system 110 generates and outputs a model notation or combination of model notations by processing the process document with a deep leaning model. For example, the process document importer 116 may transmit a request with the provided imported process document and the prompt to the NLP module 118 to generate the model notation and the NLP module 118 may tokenize and parse the process document and generate the model notation based on the prompt using deep learning techniques including, but not limited to, the LLM.

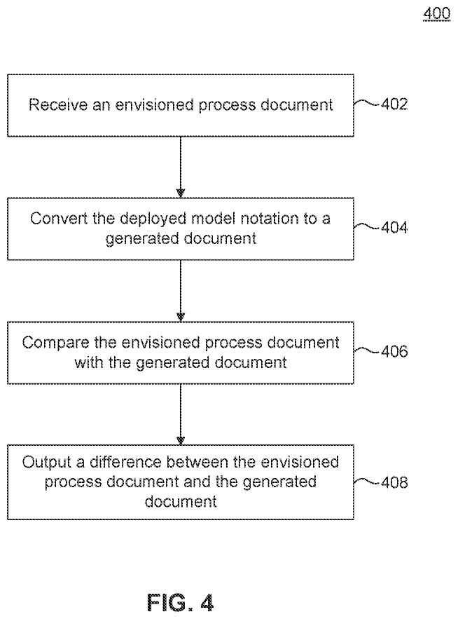

FIG. 4 is a flowchart for a method 400 for a difference generation, according to an embodiment. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4 as will be understood by a person of ordinary skill in the art. Method 400 shall be described with reference to FIGS. 1 and 2. However, method 400 is not limited to that example embodiment.

In 402, the process modeling system 110 receives the envisioned process document in the user locale.

In 404, the process modeling system 110 converts the model notation of a deployed process to a generated document for deployed process. For example, the process exporter 146 may convert the deployed model notation to the generated document for deployed process in the natural language in locale of envisioned process document by generating a predetermined string corresponding to each object included in the deployed model notation.

In 406, the process modeling system 110 compares the envisioned process document with the generated document for deployed process. For example, the process comparator 140 may compare the envisioned process document with the generated document for deployed process. In particular, the context analyzer 142 may fragment the envisioned process document and the generated document for deployed process based on related activities context and the process diff document generator 144 may generate the difference between the envisioned process document and the generated document for deployed process.

In 408, the process modeling system 110 outputs a difference between the envisioned process document and the generated document for deployed process based on the comparison of 406 For example, the process comparator 140 may output the difference between the envisioned process document and the generated document for deployed process.

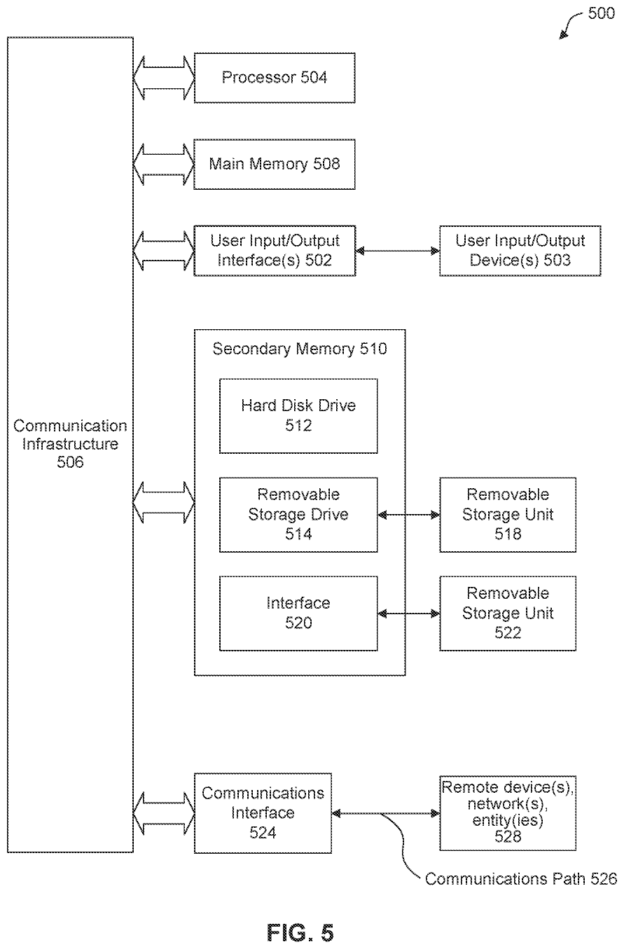

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). A GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for generating a model notation, comprising:
receiving, by at least one processor, a process document describing a process in a user locale;
generating the model notation in accordance with a model notation format by processing the process document with a deep learning technique based on a prompt for modeling the process document; and
outputting the model notation.

2. The computer-implemented method of claim 1, wherein the deep learning technique is a large language model (LLM) and the method further comprising:
converting the model notation to a generated document in the user locale by generating a predetermined string based on a parameterized template, wherein the predetermined string corresponds to an object included in the model notation.

3. The computer-implemented method of claim 2, further comprising:
comparing an envisioned process document describing a process in the user locale with the generated document and
outputting a difference between the envisioned process document and the generated document.

4. The computer-implemented method of claim 3, wherein comparing the envisioned process document with the generated document comprises:
extracting contexts from the envisioned process document and the generated document; and
comparing the contexts to determine the difference.

5. The computer-implemented method of claim 1, further comprising:
detecting, using the deep learning technique, that the process document includes a usage of personal information; and
in response to detecting usage of personal information, outputting a notification indicating that that the process document includes the usage of the personal information.

6. The computer-implemented method of claim 1, further comprising:
detecting that the model notation contains an error with respect to the model notation format; and
in response to the detecting, outputting a notification indicating that the model notation contains the error.

7. The computer-implemented method of claim 1, wherein the method for generating the model notation comprises:
determining, using the deep learning technique, the model notation format from at least one of business process modeling notation (BPMN), case management model and notation (CMMN), and decision model and notation (DMN) to model the process document based on context of the process document; and
generating the model notation in accordance with the determined model notation format by processing the process document with the deep learning technique based on the prompt.

8. A system for generating a model notation, comprising:
a memory; and
at least one processor coupled to the memory and configured to:
receive a process document describing a process in a user locale;
generate the model notation in accordance with a model notation format by processing the process document with a deep learning technique based on a prompt for modeling the process document; and
output the model notation.

9. The system of claim 8, wherein the deep learning technique is a large language model (LLM) and the at least one processor further configured to:
convert the model notation to a generated document in the user locale by generating a predetermined string based on a parameterized template, wherein the string corresponds to an object included in the model notation.

10. The system of claim 9, the at least one processor further configured to:
compare an envisioned process document describing a process in the user locale with the generated document; and
output a difference between the envisioned process document and the generated document.

11. The system of claim 10, wherein to compare the envisioned process document with the generated document, the at least one processor is configured to:
extract contexts from the envisioned process document and the generated document; and
compare the contexts to determine the difference.

12. The system of claim 8, the at least one processor further configured to:
detect, using the deep learning technique, that the process document includes a usage of personal information; and
in response to detecting usage of personal information, output a notification indicating that that the process document includes the usage of the personal information.

13. The system of claim 8, the at least one processor further configured to:
detect that the model notation contains an error with respect to the model notation format; and
in response to the detecting, output a notification indicating that the model notation contains the error.

14. The system of claim 8, wherein to generate the model notation, the at least one processor further configured to:
determine, using the deep learning technique, the model notation format from at least one of business process modeling notation (BPMN), case management model and notation (CMMN), and decision model and notation (DMN) to model the process document based on context of the process document; and
generate the model notation in accordance with the determined model notation format by processing the process document with the deep learning technique based on the prompt.

15. A non-transitory computer-readable medium having instructions stored thereon that, when executed by at least one computing device, cause the at least one computing device to perform operations comprising:
receiving a process document describing a process in a user locale;
generating a model notation in accordance with a model notation format by processing the process document with a deep learning technique based on a prompt for modeling the process document; and
outputting the model notation.

16. The non-transitory computer-readable medium of claim 15, wherein the deep learning technique is a large language model (LLM) and the operations further comprising:
converting the model notation to a generated document in the user locale by generating a predetermined string based on a parameterized template, wherein the string corresponds to an object included in the model notation.

17. The non-transitory computer-readable medium of claim 16, the operations further comprising:
comparing an envisioned process document describing a process in the user locale with the generated document; and
outputting a difference between the envisioned process document and the generated document.

18. The non-transitory computer-readable medium of claim 17, wherein comparing the envisioned process document with the generated document comprises:
extracting contexts from the envisioned process document and the generated document; and
comparing the contexts to determine the difference.

19. The non-transitory computer-readable medium of claim 15, the operations further comprising:
detecting, using the deep learning technique, that the process document includes a usage of personal information; and
in response to detecting usage of personal information, outputting a notification indicating that that the process document includes the usage of the personal information.

20. The non-transitory computer-readable medium of claim 15, wherein generating the model notation comprises:
determining, using the deep learning technique, the model notation format from at least one of business process modeling notation (BPMN), case management model and notation (CMMN), and decision model and notation (DMN) to model the process document based on context of the process document; and
generating the model notation in accordance with the determined model notation format by processing the process document with the deep learning technique based on the prompt.
